(19) United States
(12) Patent Application Publication
(10) Pub. No.: US 2016/0110396 A1
(43) Pub. Date: Apr. 21, 2016

(54) DATA PROCESSING APPARATUSES, METHODS, AND NON-TRANSITORY TANGIBLE MACHINE-READABLE MEDIUM THEREOF

(71) Applicant: MACRODATA, INC., Grand Cayman (KY)

(72) Inventors: Yi-Cheng HUANG, New Taipei City (TW); Wenwey HSEUSH, New Taipei City (TW); Yu-Chun LAI, New Taipei City (TW); Yi-Hung JEN, New Taipei City (TW)

(21) Appl. No.: 14/519,585

(22) Filed: Oct. 21, 2014

(51) Int. Cl. G06F 17/30

(52) U.S. Cl. CPC G06F 17/30339

(57) ABSTRACT

Data processing apparatuses, methods, and non-transitory tangible machine-readable medium thereof are provided. The data processing method accesses a dimension table. The dimension table is defined with a plurality of attributes and includes at least one member. Each of the at least one member includes a plurality of attribute values corresponding to the attributes. The data processing method generates a smart index for each of the distinct attribute values. Each of the smart indexes includes a first value equivalent to one of the attribute values, a second value equivalent to the attribute corresponding to the first value, and a third value indicating a rank of the first value comparing to the rest attribute values corresponding to the second value, the first values are distinct. The data processing method integrates the smart indexes into a smart index record, wherein each of the smart indexes has an index within the smart index record.

### CROSS-REFERENCES TO RELATED APPLICATIONS

Not applicable.

### BACKGROUND OF THE INVENTION

1. Field of the Invention

The present invention relates to data processing apparatuses, methods, and non-transitory tangible machine-readable medium thereof. More particularly, the present invention relates to data processing apparatuses, methods, and non-transitory tangible machine-readable medium thereof with smart index.

2. Descriptions of the Related Art

With the rapid development in computer technologies, most enterprises collect, store, manipulate, and organize business information/data in computers in a systematic way. Relational databases and on-line analytical processing (OLAP) are examples of commonly adopted technologies.

Although various commercial products of relational databases and OLAP have been developed, they have shortcomings when the amount of business data being stored becomes huge. There are occasions that a business manager would like to analyze the huge amount of data stored in a database, such as by applying a join operation or a roll-up operation to these data. However, databases on the market today cannot provide a quick response when the amount of data being processed is huge. Accessing and analyzing millions or billions records usually take significant amount of time. For business managers that have to perform analysis and make quick decisions based on big data, the long-processing time of the databases on the market today is intolerable.

According to the above description, data processing apparatuses, methods, and non-transitory tangible machine-readable medium thereof that can rapidly process big/huge/large data is in an urgent need.

### SUMMARY OF THE INVENTION

An objective of the present invention is to provide a data processing apparatus, which comprises a storage unit and a processor electrically connected to the storage unit. The storage unit is stored with a dimension table. The dimension table is defined with a plurality of attributes and comprises at least one member, wherein each of the at least one member comprises a plurality of attribute values corresponding to the attributes one-on-one. The processor is configured to generate a smart index for each of the distinct attribute values and integrate the smart indexes into a smart index record. Each of the smart indexes comprises a first value equivalent to one of the attribute values, a second value equivalent to the attribute corresponding to the first value, and a third value indicating a rank of the first value comparing to the rest attribute values corresponding to the second value. The first values are distinct. Each of the smart indexes has an index within the smart index record.

Another objective of the present invention is to provide a data processing method for use in an electronic apparatus. The method comprises the following steps of: (a) accessing a dimension table, wherein the dimension table is defined with a plurality of attributes and comprises at least one member, wherein each of the at least one member comprises a plurality of attribute values corresponding to the attributes one-on-one, (b) generating a smart index for each of the distinct attribute values, wherein each of the smart indexes comprises a first value equivalent to one of the attribute values, a second value equivalent to the attribute corresponding to the first value, and a third value indicating a rank of the first value comparing to the rest attribute values corresponding to the second value, the first values are distinct, and (c) integrating the smart indexes into a smart index record, wherein each of the smart indexes has an index within the smart index record.

A further objective of the present invention is to provide a non-transitory tangible machine-readable medium, which is stored with a computer program. The computer program comprises a plurality of codes, wherein the codes are able to execute a data processing method when the computer program is loaded into an electronic apparatus. The data processing method comprising the steps of: (a) accessing a dimension table, wherein the dimension table is defined with a plurality of attributes and comprises at least one member, wherein each of the at least one member comprises a plurality of attribute values corresponding to the attributes one-on-one, (b) generating a smart index for each of the distinct attribute values, wherein each of the smart indexes comprises a first value equivalent to one of the attribute values, a second value equivalent to the attribute corresponding to the first value, and a third value indicating a rank of the first value comparing to the rest attribute values corresponding to the second value, the first values are distinct, and (c) integrating the smart indexes into a smart index record, wherein each of the smart indexes has an index within the smart index record.

According to the above descriptions, the present invention generates a smart index for each of the distinct attribute values in the dimension table(s) and integrates these smart indexes in a smart index record. Each of the smart indexes comprises a first value equivalent to one of the distinct attribute values, a second value equivalent to the attribute that the first value corresponds to, and at least a third value indicating a rank of the first value comparing to the rest attribute values corresponding to the second value.

Depending on different scenarios, the third value of a smart index may be of different values. In some embodiments, the third value of a smart index may be a row number of the first value comparing to the rest attribute values corresponding to the second value within the dimension table. For these embodiments, a join operation can be performed efficiently. Yet in some other embodiments, the third value of a smart index may be a process order of the first value comparing to the rest attribute values corresponding to the second value within the dimension table.

The detailed technology and preferred embodiments implemented for the subject invention are described in the following paragraphs accompanying the appended drawings for people skilled in this field to well appreciate the features of the claimed invention.

### BRIEF DESCRIPTION OF THE DRAWINGS

FIG. 1 illustrates a schematic view of a data processing apparatus 1 of the present invention;

FIG. 2A illustrates the content of the dimension table 20;

FIG. 2B illustrates the content of the dimension table 22;

FIG. 2C illustrates the content of the fact table 24;

FIG. 2D illustrates the smart index record 26 of the first embodiment;

FIG. 2E illustrates the transformed fact table 24;

FIG. 2F illustrates the extended fact table 24′ generated by a join operation;

FIG. 2G illustrates the transformed extended fact table 24′;

FIG. 3 illustrates the smart index record 30 of the second embodiment;

FIG. 4 illustrates the smart index record 40 of the third embodiment;

FIG. 5A and FIG. 5B illustrates the flowchart of the fourth embodiment; and

FIG. 6A and FIG. 6B illustrates the flowchart of the fifth embodiment.

### DESCRIPTION OF THE PREFERRED EMBODIMENT

In the following descriptions, data processing apparatuses, methods, and non-transitory tangible machine-readable medium thereof of the present invention will be explained with reference to embodiments thereof. However, these embodiments are not intended to limit the present invention to any specific environment, applications, or particular implementations described in these embodiments. Therefore, description of these embodiments is only for purpose of illustration rather than to limit the present invention. It should be appreciated that elements unrelated to the present invention are omitted from depiction in the following embodiments and the attached drawings.

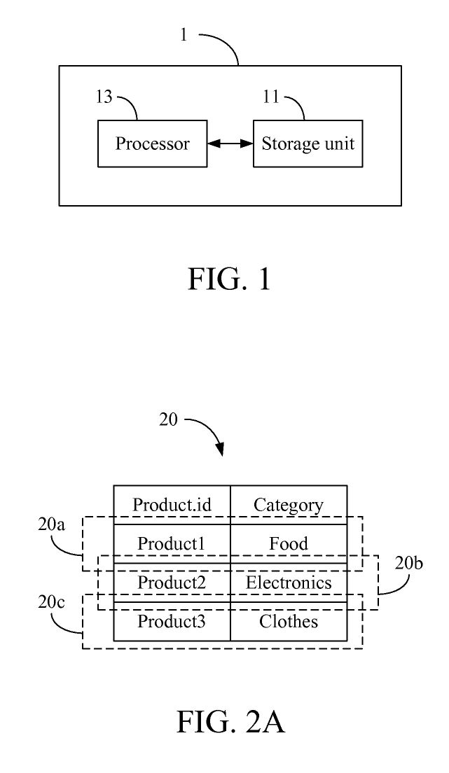

FIG. 1 illustrates a schematic view of a data processing apparatus 1 of the present invention. The data processing apparatus 1 comprises a storage unit 11 and a processor 13, wherein the processor 13 is electrically connected to the storage unit 11. The storage unit 11 may be a memory, a floppy disk, a hard disk, a compact disk (CD), a mobile disk, a magnetic tape, a database accessible to networks, or any other storage media with the same function and well-known to persons having ordinary skill in the art. The processor 13 may be any of various processors, central processing units (CPUs), microprocessors, or other computing devices well known to persons having ordinary skill in the art. The following embodiments will be described with reference to the data processing apparatus 1.

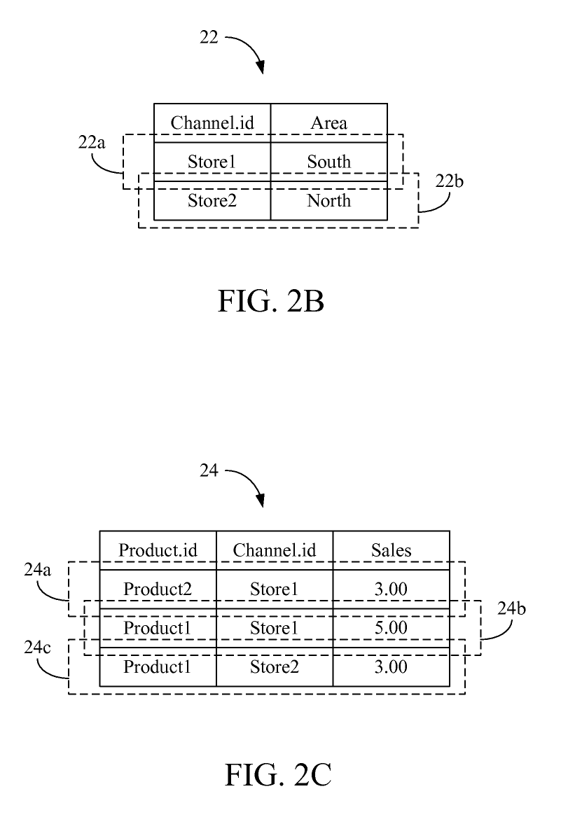

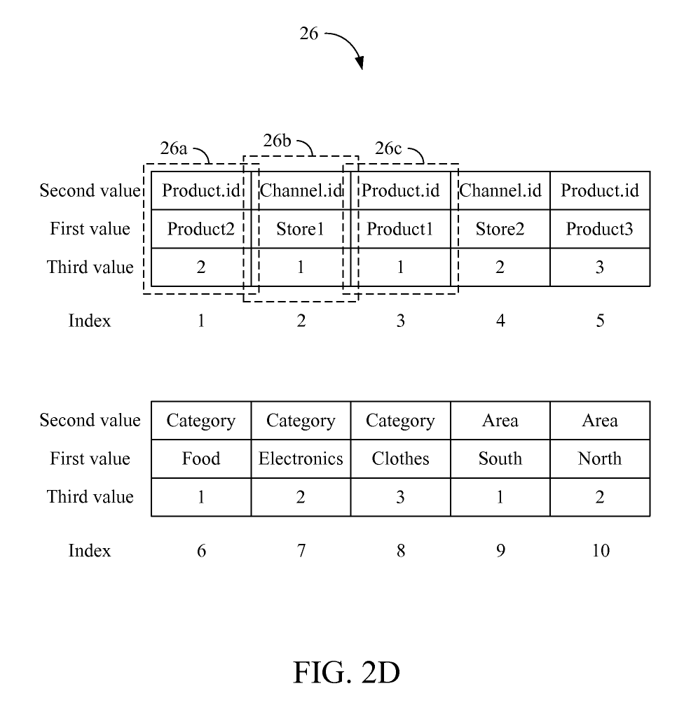

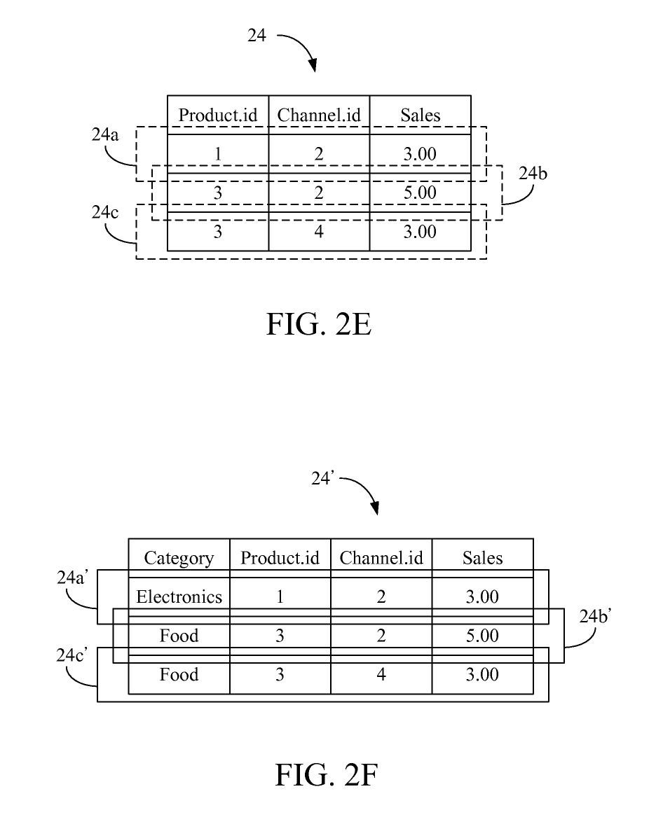

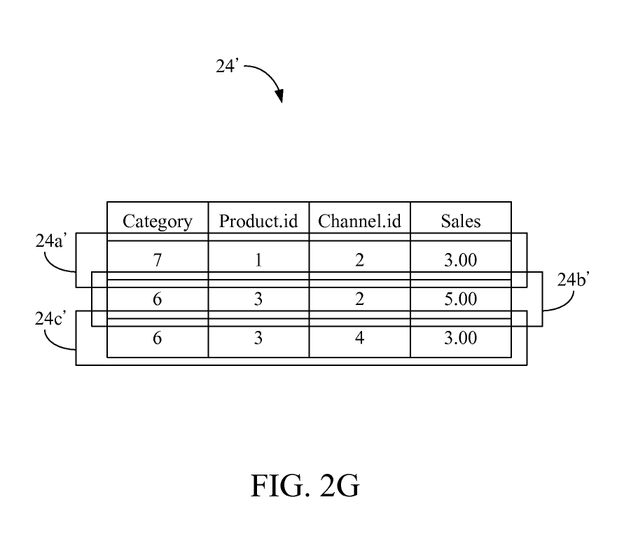

Please refer to FIGS. 1, 2A, 2B, 2C, 2D, 2E, 2F, and 2G for a first embodiment of the present invention. The storage unit 11 is stored with two dimension tables 20, 22 and a fact table 24. Please be noted that the present invention does not limit the number of the dimension tables and the number of the fact tables stored in the storage unit 11.

The content of the dimension table 20 is illustrated in FIG. 2A. The dimension table 20 is defined with a plurality of attributes (i.e. “Product.id” and “Category” as shown in FIG. 2A). The dimension table 20 comprises a plurality of members 20a, 20b, 20c, wherein each of the members 20a, 20b, 20c comprises a plurality of attribute values corresponding to the attributes of the dimension table 20 one-on-one. To be more specific, the member 20a has a first attribute value (i.e. “Product1”) corresponding to the first attribute (i.e. “Product.id”) and a second attribute value (i.e. “Food”) corresponding to the second attribute (i.e. “Category”), the member 20b has a first attribute value (i.e. “Product2”) corresponding to the first attribute (i.e. “Product.id”) and a second attribute value (i.e. “Electronics”) corresponding to the second attribute (i.e. “Category”), and the member 20c has a first attribute value (i.e. “Product3”) corresponding to the first attribute (i.e. “Product.id”) and a second attribute value (i.e. “Clothes”) corresponding to the second attribute (i.e. “Category”).

One of the attributes “Product.id” and “Category” of the dimension table 20 is a key attribute and the rest of the attributes is at least one descriptive attribute. To be more specific, the attribute “Product.id” is the key attribute and the attribute “Category” is the descriptive attribute. The attribute values (i.e. “Product1,” “Product2,” and “Product3”) that correspond to the key attribute are the key values, while the attribute values (i.e. “Food,” “Electronics,” and “Clothes”) that corresponds to the descriptive attribute are the descriptive values.

The content of the dimension table 22 is illustrated in FIG. 2B. The dimension table 22 is defined with a plurality of attributes (i.e. “Channel.id” and “Area” as shown in FIG. 2B). The dimension table 22 comprises a plurality of members 22a, 22b, wherein each of the members 22a, 22b comprises a plurality of attribute values corresponding to the attributes of the dimension table 22 one-on-one. To be more specific, the member 22a has a first attribute value (i.e. “Store1”) corresponding to the first attribute (i.e. “Channel.id”) and a second attribute value (i.e. “South”) corresponding to the second attribute (i.e. “Area”) and the member 22b has a first attribute value (i.e. “Store2”) corresponding to the first attribute (i.e. “Channel.id”) and a second attribute value (i.e. “North”) corresponding to the second attribute (i.e. “Area”).

One of the attributes “Channel.id” and “Area” is a key attribute and the rest of the attributes is at least one descriptive attribute. Particularly, the attribute “Channel.id” is the key attribute and the attribute “Area” is the descriptive attribute. The attribute values (i.e. “Store1” and “Store2”) that correspond to the key attribute are the key values, while the attribute values (i.e. “South” and “North”) that corresponds to the descriptive attribute are the descriptive values.

It should be noted that the present invention does not limit the number of the attributes and the number of the members in each dimension table. That is, the aforesaid dimension tables 20, 22 are simply two exemplary dimension tables of the present invention.

In some other embodiments, the processor 13 may further transform each of the attributes and the distinct attribute values of the dimension tables 20, 22 into a unique integer.

A encoding mechanism is adopted for such transformations. For the embodiments that each of the attributes and the distinct attribute values is transformed into a unique integer, dimension tables 20, 22 and the fact table 24 may be stored more compactly.

The content of the fact table 24 is illustrated in FIG. 2C. The fact table 24 is defined with two key attributes (i.e. “Product.id” and “Channel.id”) and a data field (i.e. “Sales”), wherein each of the key attributes of the fact table 24 is a key attribute of one of the dimension tables 20, 22. The fact table 24 comprises three fact records 24a, 24b, 24c. Each of the fact records 24a, 24b, 24c comprises a first value corresponding to one of the key attribute, a second value corresponding to another key attribute, and a piece of data corresponding to the data field, wherein each of the first value and the second value is equivalent to one of the key values of one of the dimension tables 20, 22.

To be more specific, the fact record 24a comprises a first value (i.e. “Product2”) equivalent to one of the key values of the dimension table 20, a second value (i.e. “Store1”) equivalent to one of the key values of the dimension table 22, and the piece of data (i.e. 3.00). The fact record 24b comprises a first value (i.e. “Product1”) equivalent to one of the key values of the dimension table 20, a second value (i.e. “Store1”) equivalent to one of the key values of the dimension table 22, and the piece of data (i.e. 5.00). The fact record 24c comprises a first value (i.e. “Product1”) equivalent to one of the key values of the dimension table 20, a second value (i.e. “Store2”) equivalent to one of the key values of the dimension table 22, and the piece of data (i.e. 3.00). The first values of the fact records 24a, 24b, 24c correspond to the key attribute (i.e. “Product.id”), while the second values of the fact records 24a, 24b, 24c correspond to the key attribute (i.e. “Channel.id”).

It should be noted that the present invention does not limit the number of key attributes and the number of fact records in a fact table. That is, the aforesaid fact table 24 is simply an exemplary fact table of the present invention.

In this embodiment, the processor 13 generates a smart index for each of the distinct attribute values (i.e. “Product2,” “Store1,” “Product1,” “Store2,” “Product3,” “Food,” “Electronics,” “Clothes,” “South,” and “North”) in the dimension tables 20, 22 and integrates the smart indexes into a smart index record 26 as shown in FIG. 2D. Each of the smart indexes comprises a first value equivalent to one of the attribute values, a second value equivalent to the attribute corresponding to the first value, and a third value indicating a rank of the first value comparing to the rest attribute values corresponding to the second value. Particularly, the rank in this embodiment is a row number of the first value comparing to the rest attribute values corresponding to the second value within the corresponding dimension table. It is noted that the first values of the smart indexes are distinct because these first values correspond to distinct attribute values. In addition, each of the smart indexes has an index within the smart index record 26.

The content of the smart indexes and the smart index record 26 are elaborated with several examples shown in FIG. 2D. The processor 13 generates a smart index 26a for the attribute value “Product2.” Particularly, the smart index 26a comprises a first value (i.e. “Product2”), a second value (i.e. “Product.id”) equivalent to the attribute corresponding to the first value, and a third value (i.e. 2) indicating the rank of the first value (i.e. “Product2”) comparing to the rest attribute values (i.e. “Product1” and “Product3”) corresponding to the second value (i.e. “Product.id”). As mentioned, the rank in this embodiment is the row number of the first value comparing to the rest attribute values corresponding to the second value within the dimension table 20. Since the first value (i.e. “Product2”) is stored in the second row of the dimension table 20, the third value of the smart index 26a is 2.

The processor 13 generates a smart index 26b for the attribute value “Store1.” Particularly, the smart index 26b comprises a first value (i.e. “Store1”), a second value (i.e. “Channel.id”) equivalent to the attribute corresponding to the first value, and a third value (i.e. 1) indicating the rank of the first value (i.e. “Store1”) comparing to the rest attribute values (i.e. “Store2”) corresponding to the second value (i.e. “Channel.id”). As mentioned, the rank in this embodiment is the row number of the first value comparing to the rest attribute values corresponding to the second value within the dimension table 22. Since the first value (i.e. “Store1”) is stored in the first row of the dimension table 22, the third value of the smart index 26b is 1.

The processor 13 generates a smart index 26c for the attribute value “Product1.” Particularly, the smart index 26c comprises a first value (i.e. “Product1”), a second value (i.e. “Product.id”) equivalent to the attribute corresponding to the first value, and a third value (i.e. 1) indicating the rank of the first value (i.e. “Product1”) comparing to the rest attribute values (i.e. “Product2” and “Product 3”) corresponding to the second value (i.e. “Product.id”). As mentioned, the rank in this embodiment is the row number of the first value comparing to the rest attribute values corresponding to the second value within the dimension table 20. Since the first value (i.e. “Product1”) is stored in the first row of the dimension table 22, the third value of the smart index 26c is 1.

The processor 13 also generates a smart index for each of the rest attribute values (i.e. “Store2,” “Product3,” “Food,” “Electronics,” “Clothes,” “South,” and “North”) as shown in FIG. 2D. Please be noted that the present invention does not limit the order of the attribute values when generating the smart indexes. Afterwards, the processor 13 integrates these smart indexes into a smart index record 26 and assigns an index to each of the smart indexes within the smart index record 26. For example, the index of the smart index 26a with in the smart index record 26 is 1, the index of the smart index 26b with in the smart index record 26 is 2, and etc.

Next, the processor 13 transforms each of the first values and second values in the fact table 24 to the corresponding index within the smart index record 26 as illustrated in FIG. 2E. In FIG. 2E, the first value (i.e. “Product2”) and the second value (i.e. “Store1”) of the fact record 24a are transformed into 1 (i.e. the index of “Product2” in the smart index record 26) and 2 (i.e. the index of “Store1” in the smart index record 26) respectively. The first value (i.e. “Product1”) and the second value (i.e. “Store1”) of the fact record 24b are transformed into 3 (i.e. the index of “Product1” in the smart index record 26) and 2 (i.e. the index of “Store1” in the smart index record 26) respectively. The first value (i.e. “Product1”) and the second value (i.e. “Store2”) of the fact record 24c are transformed into 3 (i.e. the index of “Product1” in the smart index record 26) and 4 (i.e. the index of “Store2” in the smart index record 26) respectively.

When a user intends to dig more information about the fact table 24, a join operation may be applied to the fact table 24 with reference to a designated descriptive attribute. The designated descriptive attribute is one of the descriptive attributes of the dimension tables 20, 22. The attribute values corresponding to the designated descriptive attribute are the information that the user intends to learn. The user may input a command including a name (or identity) of the fact table 24, the designated descriptive attribute, and the join operation through an interface (not shown) of the data processing apparatus 1. After receiving the command, the processor 13 extends the fact table 24 with the designated descriptive attribute by the join operation. It is emphasized that the transformed fact table 24 shown in FIG. 2E is used in the join operation.

For convenience, it is assumed that the designated descriptive attribute is “Category.” Nevertheless, please be noted that the designated descriptive attribute may be other ones. The extension of the fact table 24 with the designated descriptive attribute by the join operation is elaborated herein. The join operation executed by the processor 13 is applied to each of the fact records 24a, 24b, 24c. For each of the fact records 24a, 24b, 24c, the join operation locates the smart index according to the value of the fact record, retrieves the third value of the located smart index, retrieves one of the descriptive values from the dimension table according to the third value and the designated descriptive attribute, and assigns the retrieved descriptive value as an extended value corresponding to the designated descriptive attribute within the fact record. The details of applying the join operation to each of the fact records 24a, 24b, 24c is described below.

For the fact record 24a, the join operation locates a smart index according to the first value (i.e. 1) of the fact record 24a. The first value of the fact record 24a is used for locating the smart index because the first value and the designated descriptive attribute (i.e. “Category”) corresponds to the same dimension table 20. If the designated descriptive attribute corresponds to the dimension table 22, the second value (i.e. 2) will be used for locating the smart index because the second value corresponds to the dimension table 22. In this example, the smart index 26a is located because its index within the smart index record 26 is 1, which is equivalent to the first value of the fact record 24a. Then, the join operation retrieves the third value of the located smart index 26a, which is 2. As mentioned, the third value of the located smart index 26a is the row number in essential. Next, the join operation retrieves the descriptive value “Electronics” from the dimension table 20 according to the third value (i.e. 2) of the located smart index 26a and the designated descriptive attribute (i.e. “Category”). The descriptive value “Electronics” is retrieved because it is stored in the second row (indicated by the third value of the located smart index 26a) corresponding to the designated descriptive attribute (i.e. “Category”). Next, the join operation assigns the retrieved descriptive value (i.e. “Electronics”) as an extended value corresponding to the designated descriptive attribute corresponding to the fact record 24a. Please see the extended fact record 24a′ in the extended fact table 24′ in FIG. 2F.

For the fact record 24b, the join operation locates a smart index according to the first value (i.e. 3) of the fact record 24b. In this example, the smart index 26c is located because its index within the smart index record 26 is 3, which is equivalent to the first value of the fact record 24b. Then, the join operation retrieves the third value of the located smart index 26c, which is 1. As mentioned, the third value of the located smart index 26c is the row number in essential. Next, the join operation retrieves the descriptive value “Food” from the dimension table 20 according to the third value (i.e. 1) of the located smart index 26c and the designated descriptive attribute (i.e. “Category”). The descriptive value “Food” is retrieved because it is stored in the first row (indicated by the third value of the located smart index 26c) corresponding to the designated descriptive attribute (i.e. “Category”). Next, the join operation assigns the retrieved descriptive value (i.e. “Food”) as an extended value corresponding to the designated descriptive attribute corresponding to the fact record 24b. Please see the extended fact record 24b′ in the extended fact table 24′ in FIG. 2F.

As to the fact record 24c, the join operation performs similar operations as described above and results in the extended fact record 24c′ in the extended fact table 24′. The details are not repeated herein. After the derivation of the extended fact table 24′, the user is able to know the categories of each of the extended fact records 24a′, 24b′, 24c′ in the extended fact table 24′.

For better performance in the future, the processor 13 may further transforms each of the extended values in the extended fact table 24′ to the corresponding index within the smart index record 26 by similar fashion as shown in FIG. 2G. In FIG. 2G, the extended value (i.e. “Electronics”) of the extended fact record 24a′ is transformed into 7 (i.e. the index of “Electronics” in the smart index record 26). The extended value (i.e. “Food”) of the extended fact record 24b′ is transformed into 6 (i.e. the index of “Food” in the smart index record 26). Likewise, the extended value (i.e. “Food”) of the extended fact record 24c′ is transformed into 6 (i.e. the index of “Food” in the smart index record 26).

According to the above descriptions, each of the distinct attribute values (i.e. “Product2,” “Store1,” “Product1,” “Store2,” “Product3,” “Food,” “Electronics,” “Clothes,” “South,” and “North”) in the dimension tables 20, 22 has a corresponding smart index in the smart index record 26. Furthermore, each of the smart indexes comprises a first value equivalent to one of the distinct attribute values, a second value equivalent to the attribute that the first value corresponds to, and a third value indicating a rank of the first value (i.e. a row number of the first value comparing to the rest attribute values corresponding to the second value within the corresponding dimension table). With these special smart indexes, a fact table can be rapidly extended by a join operation and a designated descriptive attribute (which is one of the distinct attribute values) because attribute values corresponding to the designated descriptive attribute can be quickly located through the smart indexes. Even when a fact table comprises millions or billions fact records, a join operation still can be processed efficiently.

Please refer to FIGS. 1, 2A, 2B, 2C, 2E and 3 for a second embodiment of the present invention. In this embodiment, the storage unit 11 is also stored with two dimension tables 20, 22 and the fact table 24. The content of the dimension tables 20, 22 and the fact table 24 has been described in the first embodiment; hence, the details are not repeated herein. There are two main differences between the first and second embodiments. First, the smart indexes and the smart index record are different. Second, the operation that a user intends to execute is different. Please be noted that the following descriptions will only focused on these differences.

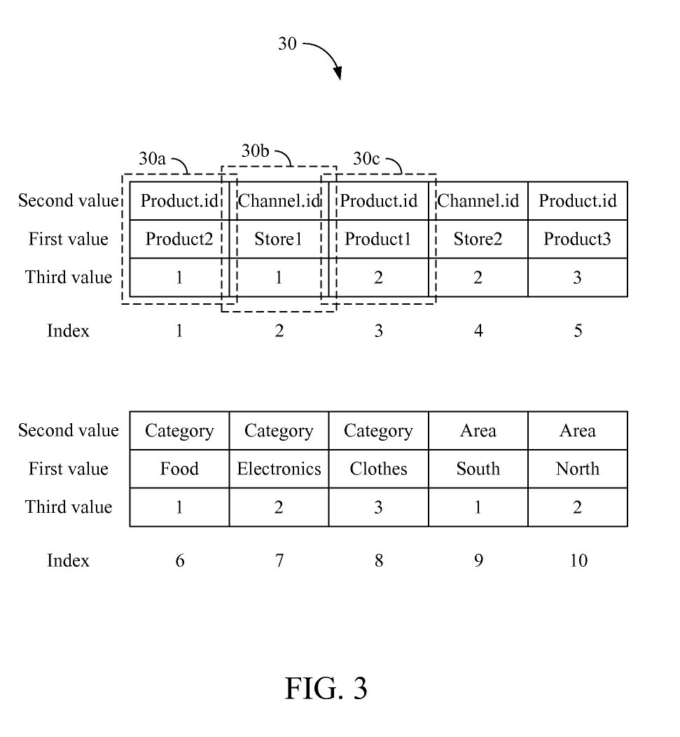

In this embodiment, the processor 13 generates a smart index for each of the distinct attribute values (i.e. “Product2,” “Store1,” “Product1,” “Store2,” “Product3,” “Food,” “Electronics,” “Clothes,” “South,” and “North”) in the dimension tables 20, 22 and integrates the smart indexes into a smart index record 30 as shown in FIG. 3. Each of the smart indexes comprises a first value equivalent to one of the attribute values, a second value equivalent to the attribute corresponding to the first value, and a third value indicating a rank of the first value comparing to the rest attribute values corresponding to the second value. Particularly, the rank in this embodiment is a process order of the first value comparing to the rest attribute values corresponding to the second value within the corresponding dimension table. It is noted that the first values of the smart indexes are distinct because these first values correspond to distinct attribute values. In addition, each of the smart indexes has an index within the smart index record 30.

The content of the smart indexes and the smart index record 30 are elaborated with several examples shown in FIG. 3. In this embodiment, the order for generating the smart indexes among these distinct attribute values is: “Product2,” “Store1,” “Product1,” “Store2,” “Product3,” “Food,” “Electronics,” “Clothes,” “South,” and “North.” However, please be noted that the present invention does not limit the order of the attribute values when generating the smart indexes.

First, the processor 13 generates a smart index 30a for the attribute value “Product2” according to the aforementioned order. The smart index 30a comprises a first value (i.e. “Product2”), a second value (i.e. “Product.id”) equivalent to the attribute corresponding to the first value, and a third value (i.e. 1) indicating the rank of the first value (i.e. “Product2”) comparing to the rest attribute values (i.e. “Product1” and “Product3”) corresponding to the second value (i.e. “Product.id”). As mentioned, the rank in this embodiment is the process order of the first value comparing to the rest attribute values corresponding to the second value within the corresponding dimension table. Since the first value (i.e. “Product2”) is the first processed attribute value among the attribute values “Product1,” “Product2,” and “Product3,” the third value of the smart index 30a is 1.

Second, the processor 13 generates a smart index 30b for the attribute value “Channel1” according to the aforementioned order. The smart index 30b comprises a first value (i.e. “Channel1”), a second value (i.e. “Channel.id”) equivalent to the attribute corresponding to the first value, and a third value (i.e. 1) indicating the rank of the first value (i.e. “Channel1”) comparing to the rest attribute values (i.e. “Channel2”) corresponding to the second value (i.e. “Channel.id”). As mentioned, the rank in this embodiment is the process order of the first value comparing to the rest attribute values corresponding to the second value within the corresponding dimension table. Since the first value (i.e. “Channel1”) is the first processed attribute value among the attribute values “Channel1” and “Channel2,” the third value of the smart index 30b is 2.

Third, the processor 13 generates a smart index 30c for the attribute value “Product1” according to the aforementioned order. The smart index 30c comprises a first value (i.e. “Product1”), a second value (i.e. “Product.id”) equivalent to the attribute corresponding to the first value, and a third value (i.e. 2) indicating the rank of the first value (i.e. “Product1”) comparing to the rest attribute values (i.e. “Product2” and “Product3”) corresponding to the second value (i.e. “Product.id”). As mentioned, the rank in this embodiment is the process order of the first value comparing to the rest attribute values corresponding to the second value within the corresponding dimension table. Since the first value (i.e. “Product1”) is the second processed attribute value among the attribute values “Product1,” “Product2,” and “Product3,” the third value of the smart index 30c is 2.

The processor 13 also generates a smart index for each of the rest attribute values (i.e. “Store2,” “Product3,” “Food,” “Electronics,” “Clothes,” “South,” and “North”) according to the aforementioned order as shown in FIG. 3. Afterwards, the processor 13 integrates these smart indexes into a smart index record 30 and assigns an index to each of the smart indexes within the smart index record 30. For example, the index of the smart index 30a with in the smart index record 30 is 1, the index of the smart index 30b with in the smart index record 30 is 2, and etc.

After the generation of the smart index record 30, the processor 13 transforms each of the first values and second values in the fact table 24 to the corresponding index within the smart index record 30 as illustrated in FIG. 2E. The details are the same as those described in the first embodiment; hence, they are not repeated herein.

When a user intends to dig more information about the fact table 24, a roll-up operation may be applied to the fact table 24 shown in FIG. 2E according to a designated key attribute of the fact table 24. It is noted that the designated key attribute is one of the key attributes of the fact table 24. It is assumed that the designated key attribute of the fact table 24 is “Product.id” for convenience; nevertheless, please be noted that the designated key attribute may be other ones. For each of the fact records 24a, 24b, 24c, the roll-up operation locates the smart index according to the value of the fact record 24, retrieves the third value of the located smart index, selects a storage space corresponding to the third value, and adds the piece of data into the selected storage space. The details of applying the roll-up operation to each of the fact records 24a, 24b, 24c is described below.

For the fact record 24a, the roll-up operation locates the smart index according to the first value (i.e. 1) of the fact record 24a. The first value of the fact record 24a is used for locating the smart index because the first value corresponds to the designated key attribute “Product.id.” In this example, the smart index 30a is located because its index within the smart index record 30 is 1, which is equivalent to the first value of the fact record 24a. Then, the roll-up operation retrieves the third value of the located smart index 30a, which is 1. Following that, the roll-up operation selects a storage space (not shown) corresponding to the third value of the smart index 30a and adds the piece of data (i.e. 3) of the fact record 24a into the selected storage space. For convenience, it is assumed that the storage space selected for the fact record 24a is denoted as S[1]. Hence, the roll-up operation adds 3 to S[1]. If the storage space is initialized to zero, S[1] will be equivalent to 3 after the process of the fact record 24a.

For the fact record 24b, the roll-up operation locates the smart index according to the first value (i.e. 3) of the fact record 24b. The first value of the fact record 24b is used for locating the smart index because the first value corresponds to the designated key attribute “Product.id.” In this example, the smart index 30c is located because its index within the smart index record 30 is 3, which is equivalent to the first value of the fact record 24b. Then, the roll-up operation retrieves the third value of the located smart index 30a, which is 2. Following that, the roll-up operation selects a storage space (not shown) corresponding to the third value of the smart index 30c and adds the piece of data (i.e. 5) of the fact record 24b into the selected storage space. For convenience, it is assumed that the storage space selected for the fact record 24b is denoted as S[2]. Hence, the roll-up operation adds 5 to S[2]. If the storage space is initialized to zero, S[2] will be equivalent to 5 after the process of the fact record 24b. As to the fact record 24c, the roll-up operation performs similar operations as described above and results in S[2] being updated to 8 (i.e. 5+3=8).

According to the above descriptions, each of the distinct attribute values (i.e. “Product2,” “Store1,” “Product1,” “Store2,” “Product3,” “Food,” “Electronics,” “Clothes,” “South,” and “North”) in the dimension tables 20, 22 has a corresponding smart index in the smart index record 30. Each of the smart indexes comprises a first value equivalent to one of the distinct attribute values, a second value equivalent to the attribute that the first value corresponds to, and a third value indicating a rank of the first value (i.e. a process order of the first value comparing to the rest attribute values corresponding to the second value within the dimension table). With these special smart indexes, a fact table can be rapidly roll-up according to a designated key attribute because the storage spaces for summing up the data of the fact records can be quickly located. Even when a fact table comprises millions or billions fact records, a roll-up operation still can be processed efficiently.

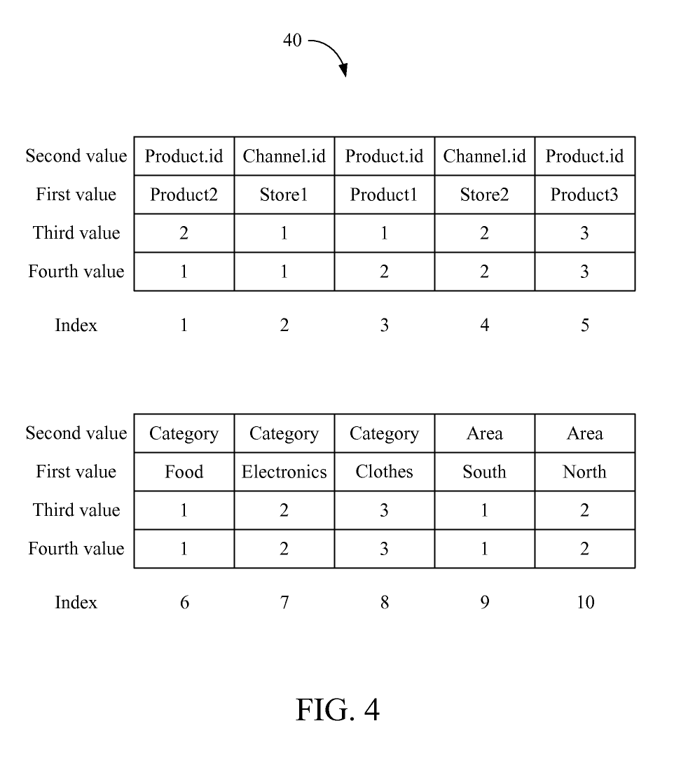

Please refer to FIGS. 1, 2A, 2B, 2C, 2E and 4 for a third embodiment of the present invention. In this embodiment, the storage unit 11 is also stored with two dimension tables 20, 22 and the fact table 24. The content of the dimension tables 20, 22 and the fact table 24 has been described in the first embodiment; hence, the details are not repeated herein. The difference between the third embodiments and the aforesaid two embodiments is the third embodiment integrates the smart indexes generated in the aforesaid two embodiments as shown in FIG. 4. The following descriptions will only focused on the difference.

In this embodiment, the processor 13 generates a smart index for each of the distinct attribute values (i.e. “Product2,” “Store1,” “Product1,” “Store2,” “Product3,” “Food,” “Electronics,” “Clothes,” “South,” and “North”) in the dimension tables 20, 22 and integrates the smart indexes into a smart index record 40 as shown in FIG. 4. Each of the smart indexes comprises a first value equivalent to one of the attribute values, a second value equivalent to the attribute corresponding to the first value, a third value indicating a row number of the first value comparing to the rest attribute values corresponding to the second value within the corresponding dimension table, and a fourth value indicating the process order of the first value comparing to the rest attribute values corresponding to the second value within the corresponding dimension table.

The details for generating the third value for each smart index are the same as those described in the first embodiment, while the details for generating the fourth value for each smart index are the same as those described in the second embodiment. Hence, the details are not repeated herein. Since each of the smart indexes has a third value and a fourth value, both join operation and roll-up operation can be performed efficiently in this embodiment.

In addition to the aforesaid operations, the third embodiment can also execute all the operations and functions set forth in the first and second embodiments. How the third embodiment executes these operations and functions will be readily appreciated by those of ordinary skill in the art based on the explanation of the first and second embodiments, and thus will not be further described herein.

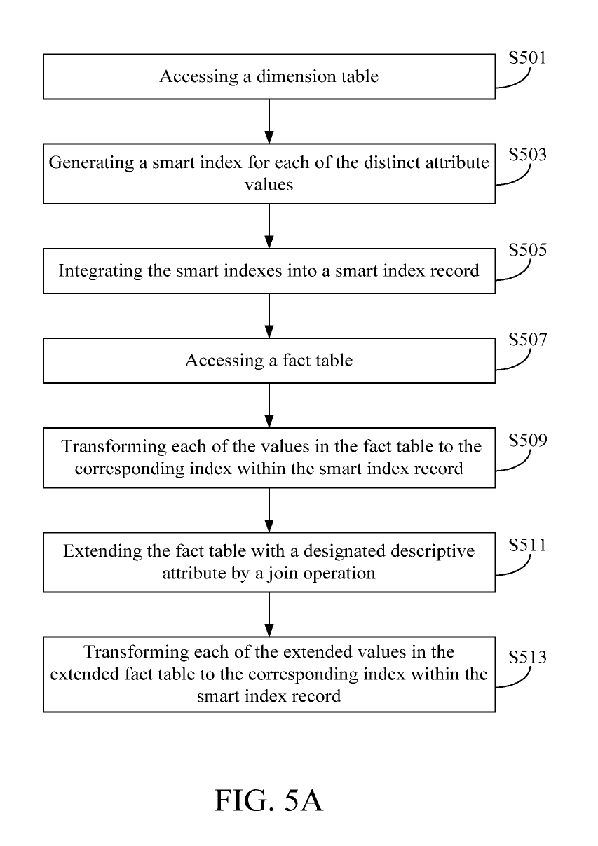

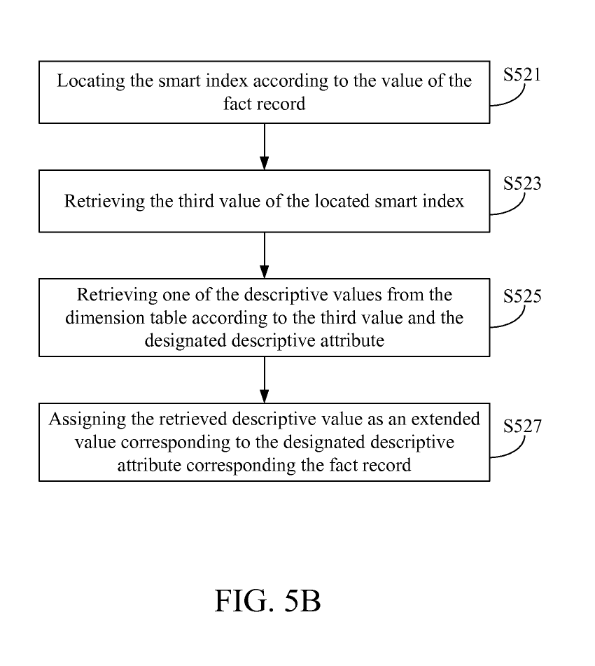

A fourth embodiment of the present invention is a data processing method for use in an electronic apparatus (e.g. the data processing apparatus 1) and a flowchart of the data processing method is illustrated in FIG. 5A and FIG. 5B.

First, step S501 is executed by the electronic apparatus for accessing a dimension table. The dimensional table may be stored in the electronic apparatus or a storage external to the electronic apparatus. The dimension table is defined with a plurality of attributes and comprises at least one member, wherein each of the at least one member comprises a plurality of attribute values corresponding to the attributes one-on-one. One of the attributes is a key attribute and the rest of the attributes is at least one descriptive attribute. The attribute values that correspond to the key attribute are the key values, while the attribute values that corresponds to the at least one descriptive attribute are the descriptive values.

In some embodiments, another step (not shown) may be executed by the electronic apparatus after the execution of the step S501 for transforming each of the attributes and the distinct attribute values into a unique integer.

Next, step S503 is executed by the electronic apparatus for generating a smart index for each of the distinct attribute values. Each of the smart indexes comprises a first value equivalent to one of the attribute values, a second value equivalent to the attribute corresponding to the first value, and a third value indicating a rank of the first value comparing to the rest attribute values corresponding to the second value, the first values are distinct. In this embodiment, the rank is a row number of the first value comparing to the rest attribute values corresponding to the second value within the dimension table. Following that, step S505 is executed by the electronic apparatus for integrating the smart indexes into a smart index record, wherein each of the smart indexes has an index within the smart index record.

After that, step S507 is executed by the electronic apparatus for accessing a fact table. The fact table may be stored in the electronic apparatus or a storage external to the electronic apparatus. The fact table is defined with the key attribute and a data field and comprises at least one fact record. Each of the at least one fact record comprises a value equivalent to one of the key values and a piece of data corresponding to the data field. Following that, step S509 is executed by the electronic apparatus for transforming each of the values in the fact table to the corresponding index within the smart index record.

Next, step S511 is executed by the electronic apparatus for extending the fact table with a designated descriptive attribute by a join operation, wherein the designated descriptive attribute is one of the at least one descriptive attribute. To be more specific, for each of the fact records, the join operation executes the steps illustrated in FIG. 5B. As shown in FIG. 5B, step S521 is executed by the electronic apparatus for locating the smart index according to the value of the fact record. Next, step S523 is executed by the electronic apparatus for retrieving the third value of the located smart index. Following that, step S525 is executed by the electronic apparatus for retrieving one of the descriptive values from the dimension table according to the third value and the designated descriptive attribute. After that, step S527 is executed the electronic apparatus for assigning the retrieved descriptive value as an extended value corresponding to the designated descriptive attribute corresponding the fact record. After the steps S521, S523, S525, and S527 have been applied to every fact record of the fact table, the join operation has been completed.

After the step S511, step S513 is executed by the electronic apparatus for transforming each of the extended values in the extended fact table to the corresponding index within the smart index record.

In addition to the aforesaid steps, the fourth embodiment can also execute all the operations and functions set forth in the first embodiment. How the fourth embodiment executes these operations and functions will be readily appreciated by those of ordinary skill in the art based on the explanation of the first embodiment, and thus will not be further described herein.

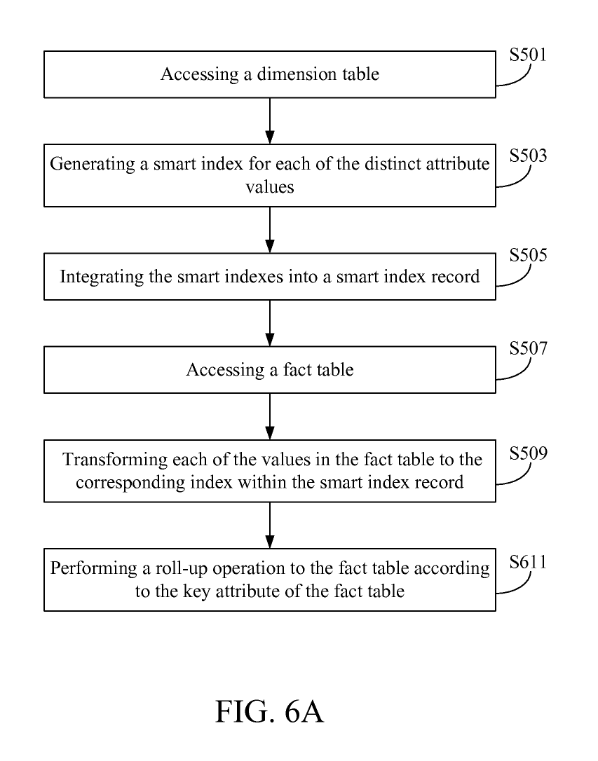

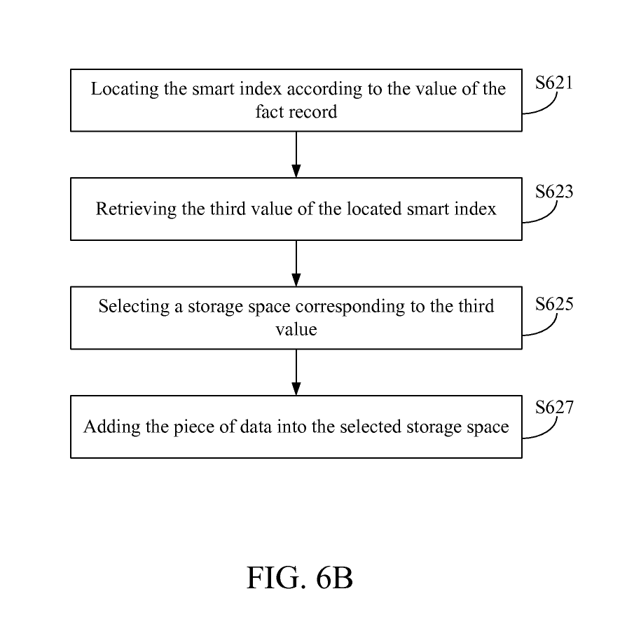

A fifth embodiment of the present invention is a data processing method for use in an electronic apparatus (e.g. the data processing apparatus 1) and a flowchart of the data processing method is illustrated in FIG. 6A and FIG. 6B.

In this embodiment, the aforementioned steps S501, S503, S505, S507, and S509 are also executed by the electronic apparatus. In this embodiment, the smart indexes generated in the step S503 are a little bit different from those generated in the fourth embodiment. The step S503 generates a smart index for each of the distinct attribute values, wherein each of the smart indexes comprises a first value equivalent to one of the attribute values, a second value equivalent to the attribute corresponding to the first value, and a third value indicating a rank of the first value comparing to the rest attribute values corresponding to the second value. Particularly, the rank is a process order of the first value comparing to the rest attribute values corresponding to the second value within the dimension table. For the rest steps S501, S505, S507, and S509, they are the same as those described in the fourth embodiment; hence, the details are not repeated herein.

In this embodiment, step S611 is executed by the electronic apparatus after the execution of the step S509. To be more specific, step S611 is executed for performing a roll-up operation to the fact table according to the key attribute of the fact table. To be more specific, for each of the fact records, the roll-up operation executes the steps illustrated in FIG. 6B. As shown in FIG. 6B, step S621 is executed by the electronic apparatus for locating the smart index according to the value of the fact record. Next, step S623 is executed by the electronic apparatus for retrieving the third value of the located smart index. Following that, step S625 is executed by the electronic apparatus for selecting a storage space corresponding to the third value. Afterwards, step S627 is executed by the electronic apparatus for adding the piece of data into the selected storage space. After the steps S621, S623, S625, and S627 have been applied to every fact record of the fact table, the roll-up operation has been completed.

In addition to the aforesaid steps, the fifth embodiment can also execute all the operations and functions set forth in the second embodiment. How the fifth embodiment executes these operations and functions will be readily appreciated by those of ordinary skill in the art based on the explanation of the second embodiment, and thus will not be further described herein.

Based on the descriptions in the fourth and fifth embodiments, persons having ordinary skill in the art are able to conceive the idea of having a sixth embodiment that combines the steps addressed in both the fourth and fifth embodiments. For the sixth embodiment, the smart indexes generated in the step S503 are a little bit different from those generated in the fourth and fifth embodiments.

To be more specific, the step S503 generating a smart index for each of the distinct attribute values. Particularly, each of the smart indexes comprises a first value equivalent to one of the attribute values, a second value equivalent to the attribute corresponding to the first value, a third value indicating a row number of the first value comparing to the rest attribute values corresponding to the second value within the corresponding dimension table, and a fourth value indicating the process order of the first value comparing to the rest attribute values corresponding to the second value within the corresponding dimension table.

Since each of the smart indexes has a third value and a fourth value, both join operation (by the steps S511, S513, S521, S523, S525, and S527) and roll-up operation (by the steps S611, S621, S623, S625, and S627) can be performed efficiently in this embodiment as well. Since these steps have been described in the fourth and fifth embodiments, the details are not repeated herein.

The data processing methods in the fourth, fifth, and sixth embodiments may be implemented as a computer program. When the computer program is loaded into an electronic apparatus, a plurality of codes comprised in the computer program are able to perform the data processing methods of the fourth, fifth, and sixth embodiments. This computer program may be stored in a tangible machine-readable medium, such as a read only memory (ROM), a flash memory, a floppy disk, a hard disk, a compact disk (CD), a mobile disk, a magnetic tape, a database accessible to networks, or any other storage media with the same function and well known to those skilled in the art.

According to the above descriptions, the present invention generates a smart index for each of the distinct attribute values in the dimension table(s) and integrates these smart indexes in a smart index record. Each of the smart indexes comprises a first value equivalent to one of the distinct attribute values, a second value equivalent to the attribute that the first value corresponds to, and at least a third value indicating a rank of the first value comparing to the rest attribute values corresponding to the second value.

Depending on different scenarios, the third value of a smart index may be of different values. In some embodiments, the third value of a smart index may be a row number of the first value comparing to the rest attribute values corresponding to the second value within the dimension table. For these embodiments, a join operation can be performed efficiently. Yet in some other embodiments, the third value of a smart index may be a process order of the first value comparing to the rest attribute values corresponding to the second value within the dimension table.

The above disclosure is related to the detailed technical contents and inventive features thereof. People skilled in this field may proceed with a variety of modifications and replacements based on the disclosures and suggestions of the invention as described without departing from the characteristics thereof. Nevertheless, although such modifications and replacements are not fully disclosed in the above descriptions, they have substantially been covered in the following claims as appended.

What is claimed is:

1. A data processing apparatus, comprising:
a storage unit, being stored with a dimension table, wherein the dimension table is defined with a plurality of attributes and comprises at least one member, each of the at least one member comprises a plurality of attribute values corresponding to the attributes one-on-one; and
a processor, being electrically connected to the storage unit and configured to generate a smart index for each of the distinct attribute values and integrate the smart indexes into a smart index record;
wherein each of the smart indexes comprises a first value equivalent to one of the attribute values, a second value equivalent to the attribute corresponding to the first value, and a third value indicating a rank of the first value comparing to the rest attribute values corresponding to the second value, the first values are distinct, and each of the smart indexes has an index within the smart index record.

2. The data processing apparatus of claim 1, wherein one of the attributes is a key attribute and the rest of the attributes is at least one descriptive attribute, the attribute values that correspond to the key attribute are the key values, the attribute values that corresponds to the at least one descriptive attribute are the descriptive values, the storage unit is further stored with a fact table, the fact table is defined with the key attribute and a data field, the fact table comprises at least one fact record, each of the at least one fact record comprises a value equivalent to one of the key values and a piece of data corresponding to the data field, and the processor further transforms each of the values in the fact table to the corresponding index within the smart index record.

3. The data processing apparatus of claim 2, wherein the rank is a row number of the first value comparing to the rest attribute values corresponding to the second value within the dimension table.

4. The data processing apparatus of claim 3, wherein the processor further extends the fact table with a designated descriptive attribute by a join operation, the designated descriptive attribute is one of the at least one descriptive attribute, wherein for each of the fact records, the join operation locates the smart index according to the value of the fact record, retrieves the third value of the located smart index, retrieves one of the descriptive values from the dimension table according to the third value and the designated descriptive attribute, and assigns the retrieved descriptive value as an extended value corresponding to the designated descriptive attribute corresponding to the fact record.

5. The data processing apparatus of claim 4, wherein the processor further transforms each of the extended values in the extended fact table to the corresponding index within the smart index record.

6. The data processing apparatus of claim 2, wherein the rank is a process order of the first value comparing to the rest attribute values corresponding to the second value within the dimension table.

7. The data processing apparatus of claim 6, wherein the processor further performs a roll-up operation to the fact table according to the key attribute of the fact table, wherein for each of the fact records, the roll-up operation locates the smart index according to the value of the fact record, retrieves the third value of the located smart index, selects a storage space corresponding to the third value, and adds the piece of data into the selected storage space.

8. The data processing apparatus of claim 5, wherein each of the smart indexes further comprises a fourth value, the fourth is a process order of the first value comparing to the rest attribute values corresponding to the second value within the dimension table, the processor further performs a roll-up operation to the extended fact table according to the designated descriptive attribute of the extended fact table, wherein for each of the fact records in the extended fact table, the roll-up operation locates the smart index according to the extended value of the fact record, retrieves the fourth value of the located smart index, selects a storage space corresponding to the retrieved fourth value, and adds the piece of data of the fact record into the selected storage space.

9. The data processing apparatus of claim 1, wherein the processor further transforms each of the attributes and the distinct attribute values into a unique integer.

10. A data processing method for use in an electronic apparatus, comprising the following steps of:
accessing a dimension table, wherein the dimension table is defined with a plurality of attributes and comprises at least one member, wherein each of the at least one member comprises a plurality of attribute values corresponding to the attributes one-on-one;
generating a smart index for each of the distinct attribute values, wherein each of the smart indexes comprises a first value equivalent to one of the attribute values, a second value equivalent to the attribute corresponding to the first value, and a third value indicating a rank of the first value comparing to the rest attribute values corresponding to the second value, the first values are distinct; and
integrating the smart indexes into a smart index record, wherein each of the smart indexes has an index within the smart index record.

11. The data processing method of claim 10, wherein one of the attributes is a key attribute and the rest of the attributes is at least one descriptive attribute, the attribute values that correspond to the key attribute are the key values, the attribute values that corresponds to the at least one descriptive attribute are the descriptive values, and the data processing method further comprises the steps of:
accessing a fact table, wherein the fact table is defined with the key attribute and a data field, the fact table comprises at least one fact record, each of the at least one fact record comprises a value equivalent to one of the key values and a piece of data corresponding to the data field; and
transforming each of the values in the fact table to the corresponding index within the smart index record.

12. The data processing method of claim 11, wherein the rank is a row number of the first value comparing to the rest attribute values corresponding to the second value within the dimension table.

13. The data processing method of claim 12, further comprising the step of:
extending the fact table with a designated descriptive attribute by a join operation, the designated descriptive attribute being one of the at least one descriptive attribute, wherein for each of the fact records the join operation comprises the following steps of:
locating the smart index according to the value of the fact record;
retrieving the third value of the located smart index;
retrieving one of the descriptive values from the dimension table according to the third value and the designated descriptive attribute; and
assigning the retrieved descriptive value as an extended value corresponding to the designated descriptive attribute corresponding the fact record.

14. The data processing method of claim 13, further comprising the step of:
transforming each of the extended values in the extended fact table to the corresponding index within the smart index record.

15. The data processing method of claim 11, wherein the rank is a process order of the first value comparing to the rest attribute values corresponding to the second value within the dimension table.

16. The data processing method of claim 15, further comprising the step of:
performing a roll-up operation to the fact table according to the key attribute of the fact table, wherein for each of the fact records, the roll-up operation comprises the following steps of:
locating the smart index according to the value of the fact record;
retrieving the third value of the located smart index;
selecting a storage space corresponding to the third value; and
adding the piece of data into the selected storage space.

17. The data processing method of claim 14, wherein each of the smart indexes further comprises a fourth value, the fourth is a process order of the first value comparing to the rest attribute values corresponding to the second value within the dimension table, and the data processing method further comprises the step of:
performing a roll-up operation to the extended fact table according to the designated descriptive attribute of the extended fact table, wherein for each of the fact records in the extended fact table, the roll-up operation comprising the steps of:
locating the smart index according to the extended value of the fact record;
retrieving the fourth value of the located smart index;
selecting a storage space corresponding to the retrieved fourth value; and
adding the piece of data of the fact record into the selected storage space.

18. The data processing method of claim 10, further comprising the step of:
transforming each of the attributes and the distinct attribute values into a unique integer.

19. A non-transitory tangible machine-readable medium, being stored with a computer program, the computer program comprising a plurality of codes, the codes being able to execute a data processing method when the computer program is loaded into an electronic apparatus, the data processing method comprising the steps of:
accessing a dimension table, wherein the dimension table is defined with a plurality of attributes and comprises at least one member, wherein each of the at least one member comprises a plurality of attribute values corresponding to the attributes one-on-one;
generating a smart index for each of the distinct attribute values, wherein each of the smart indexes comprises a first value equivalent to one of the attribute values, a second value equivalent to the attribute corresponding to the first value, and a third value indicating a rank of the first value comparing to the rest attribute values corresponding to the second value, the first values are distinct; and
integrating the smart indexes into a smart index record, wherein each of the smart indexes has an index within the smart index record.
